(19) United States
(12) Patent Application Publication
(10) Pub. No.: US 2011/0281214 A1
(43) Pub. Date: Nov. 17, 2011

(54) DEVELOPING AGENT

(75) Inventor: Koichi Kuroyama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/098,585

(22) Filed: May 2, 2011

Related U.S. Application Data
(60) Provisional application No. 61/333,369, filed on May 11, 2010.

(51) Int. Cl. G03G 9/00

(52) U.S. Cl. 430/110.4

(57) ABSTRACT

According to one embodiment, there is provided, a developing agent including a toner containing a toner particle containing a coloring agent, an amorphous polyester, a crystalline polyester having an endothermic peak temperature T1 measured by a differential scanning calorimeter, and an ester wax having an endothermic peak temperature T2 measured by a differential scanning calorimeter, and an additive composed of an inorganic oxide particle added onto the surface of the toner particle. The additive has a volume average particle size of from 80 to 200 nm. Also, the developing agent is satisfied with the following expression (1).

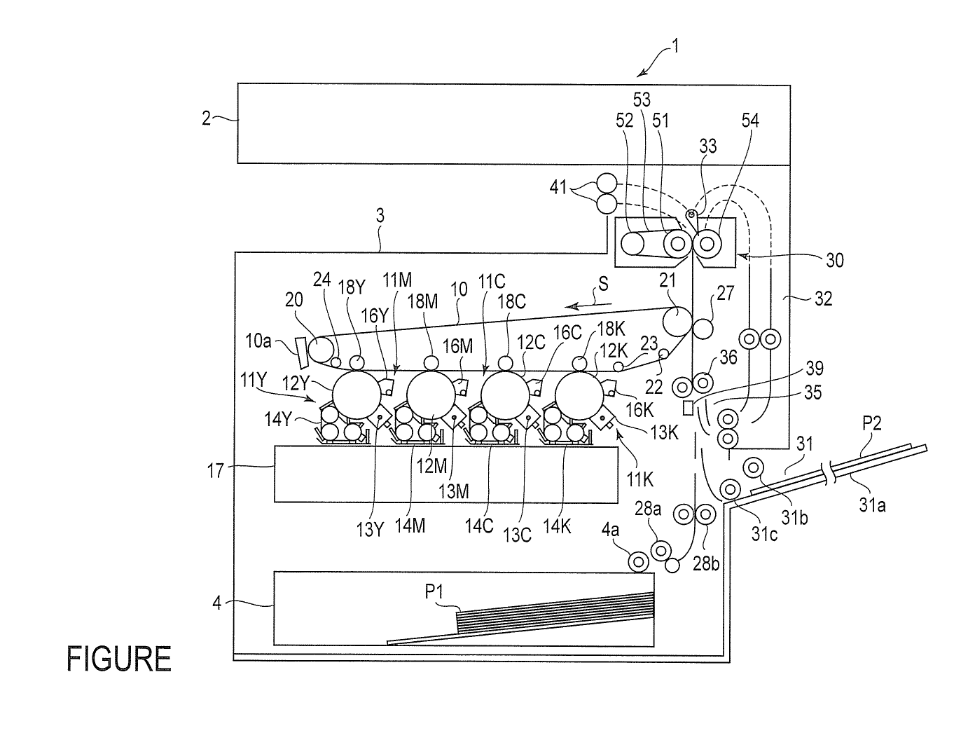

15(° C.)≦|T2−T1|≦50(° C.) (1)

### CROSS-REFERENCE TO RELATED APPLICATIONS

This application is based upon and claims the benefit of priority from U.S. Provisional Application No. 61/333,369, filed May 11, 2010, the entire contents of which are incorporated herein by reference.

### FIELD

Embodiments described herein relate generally to a developing agent for developing an electrostatic image or a magnetic latent image in, for example, an electrophotographic process, an electrostatic printing process and a magnetic recording process.

### BACKGROUND

As materials constituting a toner for forming a multicolor image, there are known an ester wax with excellent characteristics in fixability, especially resistance to high-temperature offset and a crystalline polyester resin with excellent characteristics in resistance to low-temperature offset.

For example, when an ester wax is used, in view of the fact that a straight chain of the ester wax is long, there is involved such a problem that the ester wax is poor in resistance to low-temperature offset. When this ester wax is used in combination with a crystalline polyester resin with excellent resistance to low-temperature offset, the toner Tg is largely decreased, and the low-temperature offset can be greatly improved.

However, when a difference in melting point between the ester wax and the crystalline polyester is large, there was involved such a problem that dispersion of the wax is deteriorated, the surface of a carrier in a developing agent is contaminated with the wax component, and a charge characteristic is deteriorated during the life. Also, when the difference in melting point between the ester wax and the crystalline polyester is reversely small, it may be difficult to make low-temperature offset and high-temperature offset compatible with each other.

### BRIEF DESCRIPTION OF THE DRAWINGS

FIGURE is an exemplary view showing an image forming apparatus according to an embodiment.

### DETAILED DESCRIPTION

In general, according to one embodiment, there is provided a developing agent including a toner containing a toner particle containing a coloring agent, an amorphous polyester, a crystalline polyester and an ester wax, and an additive composed of an inorganic oxide particle added onto the surface of the toner particle.

The crystalline polyester has an endothermic peak temperature T1 measured by a differential scanning calorimeter (DSC), the ester wax has an endothermic peak temperature T2 measured by DSC, and T1 and T2 satisfy the following expression (1).

15(° C.)≦|T2−T1|≦50(° C.) (1)

The inorganic oxide particle has a volume average particle size of from 80 to 200 nm.

As raw material monomers of the polyester resin component which is used in the exemplary embodiment, a dihydric or higher hydric alcohol component and a divalent or higher valent carboxylic acid component such as carboxylic acids, carboxylic acid anhydrides and carboxylic acid esters are used.

Examples of the dihydric alcohol component include alkylene oxide additives of bisphenol A, such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A and hydrogenated bisphenol A.

The dihydric alcohol component can be a bisphenol A-alkylene (carbon number: 2 or 3) oxide adduct (average addition molar number: from 1 to 10), ethylene glycol, propylene glycol, 1,6-hexanediol, bisphenol A or hydrogenated bisphenol A.

Examples of the trihydric or higher hydric alcohol component include sorbitol, 1,2,3,6-hexanetetrole, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxymethylbenzene.

The trihydric or higher hydric alcohol component can be sorbitol, 1,4-sorbitan, pentaerythritol, glycerol or trimethylolpropane.

In the exemplary embodiment, these dihydric alcohols and trihydric or higher hydric alcohols can be used singly or in combination. It is possible to use a bisphenol A-alkylene (carbon number: 2 or 3) oxide adduct (average addition molar number: from 1 to 10) as the major component.

Examples of the divalent carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkenylsuccinic acids such as n-dodecenylsuccinic acid, alkylsuccinic acids such as n-dodecylsuccinic acid, and acid anhydrides or lower alkyl esters thereof.

The divalent carboxylic acid component can be maleic acid, fumaric acid, terephthalic acid or a succinic acid substituted with an alkenyl group with a carbon number of from 2 to 20.

Examples of the trivalent or higher valent carboxylic acid component include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, enpole trimer acid, and acid anhydrides or lower alkyl esters thereof.

The trivalent or higher valent carboxylic acid component can be 1,2,4-benzenetricarboxylic acid (trimellitic acid) or an acid anhydride or alkyl (carbon number: from 1 to 12) ester thereof.

In the exemplary embodiment, these divalent carboxylic acids, etc. and trivalent or higher valent carboxylic acids, etc. can be used singly or in combination. In particular, fumaric acid, terephthalic acid or a succinic acid substituted with an alkenyl group with a carbon number of from 2 to 20, all of which are a divalent carboxylic acid component; 1,2,4-benzenetricarboxylic acid (trimellitic acid) which is a trivalent or higher valent carboxylic acid component; or an acid anhydride or alkyl (carbon number: from 1 to 12) ester thereof can be used as the major component.

In polymerizing the raw material monomers of the polyester, in order to accelerate the reaction, a usually used catalyst such as dibutyltin oxide, a titanium compound, an dialkoxytin(II), tin(II) oxide, a fatty acid tin(II), dioctanoic acid tin(II) and distearic acid tin(II) may be properly used.

Examples of the ester wax which is used in the exemplary embodiment include waxes synthesized from a long-chain alkyl carboxylic acid component and a long-chain alkyl alcohol component.

As the ester wax, one having an alkyl group with a carbon number of from 32 to 46, in which when an ion intensity ratio at each carbon number of this ester wax is expressed in terms of percentage, a content of the ester compound having a carbon number showing its maximum intensity ratio is from 20 to 55% by weight of the whole of the wax, and a content of the ester compounds with a carbon number of not more than 38 is not more than 10% by weight of the whole of the wax, can be used.

An addition amount of the ester wax is, for example, from 3 to 17% by weight in the toner particle.

When the addition amount of the ester wax is less than 3% by weight, the resistance to high-temperature offset tends to be deteriorated. On the other hand, when the addition amount of the ester wax exceeds 17% by weight, adhesion of the toner to a photoconductor or storage properties in a high-temperature environment tend to be deteriorated.

Examples of the acid component of the crystalline polyester resin which is used in the exemplary embodiment include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, n-dodecylsuccinic acid, n-dodecenylsuccinic acid, cyclohexanedicarboxylic acid, trimellitic acid, pyromellitic acid, and acid anhydrides or alkyl (carbon number: from 1 to 3) esters thereof. Above all, fumaric acid can be used. Examples of the alcohol component include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol and trimethylolpropane. Above all, 1,4-butanediol or 1,6-hexanediol can be used.

The crystalline polyester resin can be added in an amount of from 3 to 35% by weight in the toner particle.

When the addition amount of the crystalline polyester resin is less than 3% by weight, the resistance to low-temperature offset tends to be deteriorated. On the other hand, when the addition amount of the crystalline polyester resin exceeds 35% by weight, storage properties in a high-temperature environment tend to be deteriorated.

In the exemplary embodiment, a polyester resin having a ratio of softening point to melting temperature ((softening point)/(melting temperature)) of from 0.9 to 1.1 is defined as the crystalline polyester resin.

Also, when an absolute value of the difference of between the endothermic peak temperature T1 measured by a differential scanning calorimeter (DSC) of the crystalline polyester and the endothermic peak temperature T2 measured by DSC of the ester wax is less than 15° C., it may be difficult to make the resistance to low-temperature offset and the resistance to high-temperature offset compatible with each other, so that a temperature region where the offset does not occur tends to become narrow. On the other hand, when the absolute value of the difference of between the endothermic peak temperature T1 measured by DSC of the crystalline polyester and the endothermic peak temperature T2 measured by DSC of the ester wax exceeds 50° C., dispersion of the wax is deteriorated, and the surface of a carrier in a developing agent is contaminated with the wax component, so that the charge characteristic tends to be deteriorated during the life.

As the coloring agent which is used in the exemplary embodiment, carbon blacks or organic or inorganic pigments or dyes, which are used for color toner applications, can be used. In the exemplary embodiment, though the coloring agent is not particularly restricted, for example, acetylene black, furnace black, thermal black, channel black, ketjen black, etc. can be used as the carbon black. Also, for example, Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green, quinacridone, etc. can be used as the pigment or dye. These coloring agents can be used singly or in admixture. Also, though an addition amount of the coloring agent is not particularly restricted, the coloring agent can be used in an amount of from 4 to 15 parts by weight based on 100 parts by weight of the binder resin.

Examples of the charge control agent which is used in the exemplary embodiment include a metal-containing azo compound. Complexes or complex salts in which a metal element of the metal-containing azo compound is iron, cobalt or chromium, or mixtures thereof can be used. Also, a metal-containing salicylic acid derivative compound or a metal oxide hydrophobilized material can also be used, and complexes or complex salts in which a metal element thereof is zirconium, zinc, chromium or boron, or mixtures thereof can be used. For example, a clathrate compound of a polysaccharide containing aluminum and magnesium can be used. Though an addition amount of the charge control agent is not particularly restricted, it can be set to be from 0.5 to 3 parts by weight based on 100 parts by weight of the binder resin. When the addition amount of the charge control agent is less than 0.5 parts by weight, the charge quantity of the developing agent is lowered, so that the toner scattering within the machine at the life extension tends to be deteriorated. On the other hand, when the addition amount of the charge control agent exceeds 3 parts by weight, the charge quantity of the developing agent becomes high, the image density becomes insufficient, and the contamination of the carrier surface in the developing agent is deteriorated, so that the charge properties tend to become instable.

As to a measure for mixing and dispersing the raw materials, examples of a mixing machine include a Henschel mixer (manufactured by Mitsui Mining Co., Ltd.); a super mixer (manufactured by Kawata Mfg., Co., Ltd.); Ribocone (manufactured by Okawara Mfg., Co., Ltd.); a nauta mixer, a turbulizer and a cyclomixer (all of which are manufactured by Hosokawa Micron Corporation); a spiral pin mixer (manufactured by Pacific Machinery & Engineering Co., Ltd.); and a Loedige mixer (manufactured by Matsubo Corporation). Examples of a kneading machine include a KRC kneader (manufactured by Kurimoto, Ltd.); a Buss Ko-Kneader (manufactured by Buss AG); a TEM type extruder (manufactured by Toshiba Machine Co., Ltd.); a TEX twin-screw kneading machine (manufactured by The Japan Steel Works, Ltd.); a PCM kneading machine (manufactured by Ikegai, Ltd.); a three-roll mill, a mixing roll mill and a kneader (all of which are manufactured by Inoue Mfg., Inc.); Kneadex (manufactured by Mitsui Mining Co., Ltd.); an MS type pressure kneader, a kneader-ruder (manufactured by Moriyama Company Ltd.); and a Banbury mixer (manufactured by Kobe Steel, Ltd.).

Also, as to a measure for coarsely pulverizing the mixture, for example, a hammer mill, a cutter mill, a jet mill, a roller mill, a ball mill, etc. can be used. Also, examples of a pulverizer as a measure for finely pulverizing the coarsely pulverized material include a counterjet mill, Micronjet and Inomizer (all of which are manufactured by Hosokawa Micron Corporation); an IDS type mill and a PJM jet pulverizer (all of which are manufactured by Nippon Pneumatic Mfg. Co., Ltd.); Crossjet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); and Turbo Mill (manufactured by Turbo Kogyo Co., Ltd.).

Also, examples of a classifier for classifying the finely pulverized material include Classiel, Micron Classifier and Spedic Classifier (all of which are manufactured by Seisin Enterprises Co., Ltd.); Turbo Classifier (manufactured by Nisshin Engineering Co., Ltd.); Micron Separator, Turboplex (ATP) and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K. K.).

In the exemplary embodiment, for the purpose of stabilizing fluidity, charge properties or storage characteristics of the toner, an additive composed of an inorganic oxide particle having a volume average particle size of from 80 to 200 nm is added onto the toner particle surface. Examples of this inorganic oxide particle include silica, titania, alumina, strontium titanate and tin oxide. A mixture of at least two kinds of inorganic oxide fine particles having a different particle size from each other can be used. From the viewpoint of an enhancement of environmental stability, an inorganic oxide fine particle obtained through a surface treatment with a hydrophobic agent can be used.

When the volume average particle size of the inorganic oxide particle is less than 80 nm, the toner transfer efficiency onto a transfer belt or paper is deteriorated, whereas when it exceeds 200 nm, the generation of scratches on the photoconductor is caused.

Also, besides such an inorganic oxide fine particle, a resin fine particle of not more than 1 μm can be further added.

The additive can be contained in an amount of from 0.1 to 3.0% by weight in the toner.

As a measure for mixing the additive, the above-described mixing machines can be used.

Examples of a screening apparatus for classifying coarse particles or the like include Ultra Sonic (manufactured by Koei Sangyo Co., Ltd.); Resona Sieve and Gyroshifter (all of which manufactured by Tokuju Corporation); Vibrasonic System (manufactured by Dalton Co., Ltd.); Soniclean (manufactured by Shinto Kogyo Kabushiki Kaisha); Turboscreener (manufactured by Turbo Kogyo Co., Ltd.); Microshifter (manufactured by Makino Mfg. Co., Ltd.); and a circular vibrating sieve.

The formation of a toner particle can be, for example, carried out by:

melt kneading toner particle materials to form a kneaded material;

pulverizing the kneaded material to form a coarsely pulverized mixture;

mixing the coarsely pulverized mixture with an aqueous medium to form a liquid dispersion;

giving a mechanical shear to the liquid dispersion to form a fine particle of the coarsely pulverized mixture; and

aggregating the fine particle in the liquid dispersion.

FIGURE illustrates a diagrammatic view showing an example of an image forming apparatus to which the developing agent according to the exemplary embodiment is applicable.

As shown in FIGURE, a scanner section 2 and a paper discharge section 3 are provided in an upper portion of a color copier, MFP (e-studio 4520c) 1 of a quadruple tandem system.

The color copier 1 has image forming stations 11Y, 11M, 11C and 11K of four groups of yellow (Y), magenta (M), cyan (C) and black (K) disposed in parallel along a lower side of an intermediate transfer belt (intermediate transfer medium) 10.

The respective image forming stations 11Y, 11M, 11C and 11K have photoconductive drums (image carriers) 12Y, 12M, 12C and 12K, respectively. In the surroundings of the photoconductive drums 12Y, 12M, 12C and 12K, electrification chargers 13Y, 13M, 13C and 13K; development apparatuses 14Y, 14M, 14C and 14K; and photoconductor cleaning apparatuses 16Y, 16M, 16C and 16K are disposed along the rotation direction shown by an arrow S direction. On the way from the electrification chargers 13Y, 13M, 13C and 13K to the development apparatuses 14Y, 14M, 14C and 14K in the surroundings of the photoconductive drums 12Y, 12M, 12C and 12K, exposure light by a laser exposure apparatus (latent image forming apparatus) 17 is irradiated, an electrostatic latent image is formed on the photoconductive drums 12Y, 12M, 12C and 12K.

Each of the development apparatuses 14Y, 14M, 14C and 14K has a two-component developing agent composed of each of yellow (Y), magenta (M), cyan (C) and black (K) toners and a carrier, respectively and feeds the toner to the electrostatic latent image on the photoconductive drums 12Y, 12M, 12C and 12K, respectively.

The intermediate transfer belt 10 is hung by a backup roller 21, a driven roller 20 and first to third tension rollers 22 to 24. The intermediate transfer belt 10 is opposed to and brought into contact with the photoconductive drums 12Y, 12M, 12C and 12K. Primary transfer rollers 18Y, 18M, 18C and 18K for primarily transferring the toner images on the photoconductive drums 12Y, 12M, 12C and 12K onto the intermediate transfer belt 10 are provided at positions of the intermediate transfer belt 10 opposing to the photoconductive drums 12Y, 12M, 12C and 12K, respectively. Each of these primary transfer rollers 18Y, 18M, 18C and 18K is a conductive roller, and a primary transfer bias voltage is impressed in each of these primary transfer sections.

A secondary transfer roller 27 is disposed in a secondary transfer section which is a transfer position of the intermediate transfer belt 10 supported by the backup roller 21. In the secondary transfer section, the backup roller 21 is a conductive roller, and a prescribed secondary transfer bias is impressed thereto. When a sheet paper (final transfer medium) that is an object to printing passes between the intermediate transfer belt 10 and the secondary transfer roller 27, the toner image on the intermediate transfer belt 10 is secondarily transferred onto the sheet paper. After completion of the secondary transfer, the intermediate transfer belt 10 is cleaned up by a belt cleaner 10a.

A paper feed cassette 4 for feeding a sheet paper P1 toward the direction of the secondary transfer roller 27 is provided in a lower portion of the laser exposure apparatus 17. A manual-bypass mechanism 31 for manually feeding a sheet paper P2 is provided on the right side of the color copier 1.

On the way from the paper feed cassette 4 to the secondary transfer roller 27, a pickup roller 4a, a separation roller 28a, a carrying roller 28b and a resist roller pair 36 are provided, thereby constituting a paper feed mechanism. On the way from a manual-bypass tray 31a of the manual-bypass mechanism 31 to the resist roller pair 36, a manual-bypass pickup roller 31b and a manual-bypass separation roller 31c are provided.

Furthermore, a medium sensor 39 for detecting the kind of sheet paper is disposed on a vertical carrying route 35 for carrying the sheet paper from the paper feed cassette 4 or the manual-bypass tray 31a toward the direction of the secondary transfer roller 27. The color copier 1 is able to control a carrying rate of sheet paper, a transfer condition, a fixing condition and so on from the detection results by the medium sensor 39. Also, a fixing apparatus 30 is provided in the downstream of the secondary transfer section along the direction of the vertical carrying route 35.

The sheet paper taken out from the paper feed cassette 4 or fed from the manual-bypass mechanism 31 is carried into the fixing apparatus 30 through the resist roller pair 36 and the secondary transfer roller 27 along the vertical carrying route 35. The fixing apparatus 30 has a fixing belt 53 wound around a pair of a heating roller 51 and a driving roller 52 and a counter roller 54 disposed opposing to the heating roller 51 via the fixing belt 53. The sheet paper having a toner image transferred in the secondary transfer section is introduced between the fixing belt 53 and the counter roller 54, and the toner image transferred onto the sheet paper is heat treated and fixed upon heating by the heating roller 51. A gate 33 is provided in the downstream of the fixing apparatus 30, whereby the sheet paper is distributed into the direction of a paper discharge roller 41 and the direction of a recarrying unit 32. The sheet paper introduced into the paper discharge roller 41 is discharged into the paper discharge section 3. Also, the sheet paper introduced into the recarrying unit 32 is again introduced onto the direction of the secondary transfer roller 27.

The image forming station 11Y has the photoconductive drum 12Y and a process measure in an integral manner and is provided in a detachable manner relative to a main body of the image forming apparatus. The process measure as referred to herein means at least one of the electrification charger 13Y, the development apparatus 14Y and the photoconductor cleaning apparatus 16Y. Each of the image forming stations 11M, 11C and 11K has the same configuration as the image forming station 11Y. Each of the image forming stations 11Y, 11M, 11C and 11K may be detachable relative to the image forming apparatus or may be detachable as the integrated image forming unit 11 relative to the image forming apparatus.

Hereinafter, exemplary embodiments will be more specifically described by reference to the following Examples.

Various evaluation methods used in the Examples are shown below.

### Preparation Examples of Ester Waxes

In a four-necked flask equipped with a stirrer, a thermocouple and a nitrogen-introducing pipe, 80 parts by weight of a long-chain alkyl carboxylic acid component and 20 parts by weight of a long-chain alkyl alcohol component were charged and subjected to an esterification reaction at 220° C. in a nitrogen gas stream. The obtained reaction product was diluted with a mixed solvent of toluene and ethanol, to which was then added a sodium hydroxide aqueous solution, and the mixture was stirred at 70° C. for 30 minutes. Thereafter, the reaction mixture was allowed to stand for 30 minutes, thereby removing an aqueous layer part. Furthermore, an operation of adding ion-exchanged water, stirring the mixture at 70° C. for 30 minutes and then allowing the reaction mixture to stand for 30 minutes, thereby removing an aqueous layer part was repeated five times. The solvent was distilled off from the obtained ester layer under a reduced pressure condition, thereby obtaining Ester Wax (A) having an acid value of 0.1 mgKOH/g and a hydroxyl value of 0.5 mgKOH/g. A structural formula of the ester wax is expressed by the following formula (1).

CH₃(CH₂)ₙCOO(CH₂)ₘCH₃ (1)

In the formula (1), each of n and m represents a constant.

Also, each of ester waxes was prepared by changing the kind and amount of the long-chain alkyl carboxylic acid and the kind and amount of the long-chain alkyl alcohol. In particular, in the case of broadening the distribution, the adjustment was carried out by using plural kinds as to both of the long-chain alkyl carboxylic acid component and the long-chain alkyl alcohol component.

A data of each of the ester waxes is shown in Table 1.

TABLE 1

| | Content proportion of ester compound (% by weight) | | | | | | | | | Melting point | Acid value | Hydroxyl value |
|---|---|---|---|---|---|---|---|---|---|---|---|---|
| Wax | C32 | C34 | C36 | C38 | C40 | C42 | C44 | C46 | C48 | [° C.] | [mgKOH/g] | [mgKOH/g] |
| A | 0 | 0 | 2.3 | 3.1 | 13.8 | 27 | 44.7 | 3.7 | 5.4 | 68 | 0.1 | 0.5 |
| B | 0 | 0 | 0 | 2.5 | 18.5 | 15.4 | 55 | 8.6 | 0 | 74 | 0.1 | 0.4 |
| C | 0 | 0 | 6 | 3.2 | 22.4 | 22.1 | 22 | 18.9 | 5.4 | 61 | 0.1 | 0.4 |

### Long-Chain Alkyl Carboxylic Acid Component

Palmitic acid (C₁₆H₃₂O₂)

Stearic acid (C₁₈H₃₆O₂)

Arachidic acid (C₂₀H₄₀O₂)

Behenic acid (C₂₂H₄₄O₂)

Lignoceric acid (C₂₄H₄₈O₂)

### Long-Chain Alkyl Alcohol Component

Palmityl alcohol (C₁₆H₃₄O)

Stearyl alcohol (C₁₈H₃₈O)

Arachidic alcohol (C₂₀H₄₂O)

Behenyl alcohol (C₂₂H₄₆O)

Lignoceryl alcohol (C₂₄H₄₈O)

Also, the melting point of the obtained ester wax is measured using DSC (DSC Q2000, manufactured by TA Instruments). The measurement is carried out under the following condition.

Sample: 5 mg

Lid and pan: Made of alumina

Temperature elevation rate: 10° C./min

Measurement temperature: 20 to 200° C.

A data obtained by the measurement when the sample heated to 200° C. is cooled to not higher than 20° C. and again heated is employed, and a maximum endothermic peak generated at from around 60° C. to around 80° C. is defined as a melting point of the wax.

Also, a maximum endothermic peak generated at from around 80° C. to around 120° C. is defined as a melting point of the crystalline polyester resin.

For a mass analysis of the obtained ester wax, FD/MS (JMS-T100GC, manufactured by JEOL Ltd.) was used. 1 mg of a sample (dissolved in 1 mL of chloroform) was used. Under conditions at a cathode voltage of −10 kV and at a spectrum recording interval of 0.4 seconds in the measuring mass range m/z of from 10 to 2,000, the intensities of the respective carbon numbers of the ester compounds were summed and taken as 100, and a relative intensity of each carbon number was calculated, thereby confirming a maximum intensity.

Incidentally, as to Ester Wax (H) using rice wax, C54 was defined as the maximum intensity.

The acid value and hydroxyl value of the obtained ester wax were measured in conformity with JIS K0070.

### Preparation of Comparative Ester Wax (D)

The blending amounts of behenic acid and behenyl alcohol were increased, thereby preparing Comparative Ester Wax (D) in which the ester compound with a carbon number as a maximum frequency among the carbon numbers of from C32 to C46 occupied 60% or more of the whole of the wax. A data of Comparative Ester Wax (D) is shown in Table 2.

### Preparation of Comparative Ester Wax (E)

The blending amounts of stearic acid and stearyl alcohol were increased, thereby preparing Comparative Ester Wax (E) in which the ester compounds with a carbon number of not more than 38 occupied 10% or more of the whole of the wax. A data of Comparative Ester Wax (E) is shown in Table 2.

### Preparation of Comparative Ester Wax (F)

The blending amounts of stearic acid and stearyl alcohol were increased, thereby preparing Comparative Ester Wax (F) in which the ester compound with a carbon number of 40 occupied less than 20% of the whole of the wax. A data of Comparative Ester Wax (F) is shown in Table 2.

### Preparation of Comparative Ester Wax (G)

Comparative Ester Was (G) was prepared using only palmitic acid as the acid component and palmityl alcohol as the alcohol component. A data of Comparative Ester Wax (G) is shown in Table 2.

### Comparative Ester Wax (H)

Rice wax was used. A data is shown in Table 3.

TABLE 2

| | Content proportion of ester compound (% by weight) | | | | | | | | | Melting point | Acid value | Hydroxyl value |
|---|---|---|---|---|---|---|---|---|---|---|---|---|
| Wax | C32 | C34 | C36 | C38 | C40 | C42 | C44 | C46 | C48 | [° C.] | [mgKOH/g] | [mgKOH/g] |
| D | 0 | 0 | 0 | 0.5 | 6.2 | 16.4 | 73 | 1 | 2.9 | 76 | 0.1 | 0.5 |
| E | 0 | 0 | 5.3 | 6.8 | 13.8 | 27 | 40 | 2.7 | 4.4 | 65 | 0.1 | 0.5 |
| F | 0 | 5.4 | 14.7 | 13.9 | 18.7 | 9.5 | 17.8 | 13.6 | 6.4 | 63 | 0.1 | 0.3 |
| G | 100 | 0 | 0 | 0 | 0 | 0 | 0 | 0 | 0 | 59 | 0.1 | 0.4 |

TABLE 3

| | Content proportion of ester compound (% by weight) | | | | | | | | | Melting point | Acid value | Hydroxyl value |
|---|---|---|---|---|---|---|---|---|---|---|---|---|
| Wax | C46 | C48 | C50 | C52 | C54 | C56 | C58 | C60 | C62 | [° C.] | [mgKOH/g] | [mgKOH/g] |
| H | 7 | 12 | 13 | 18 | 20 | 15 | 10 | 5 | 0 | 79 | 6.3 | 15.4 |

### Evaluation of Fixing Offset

In a fixing system modification of commercially available e-studio 6530c (manufactured by Toshiba Tec Corporation), the fixing temperature was set to 130° C., and a solid image was printed on 10 sheets. In those ten sheets, the case where the image separation by offset or unfixing did not occur even slightly was defined as “Good”; and the case where the image separation occurred was defined as “Bad”.

### Life Extension and Toner Scattering

Using commercially available e-studio 6530c (manufactured by Toshiba Tec Corporation), an original with a printing ratio of 8.0% was continuously copied on 300,000 sheets of A4. At that time, the case where staining such as falling of toner, etc. to be caused due to the toner scattering was not confirmed was defined as “Good”; and the case where staining was confirmed was defined as “Bad”.

### Filming

Using commercially available e-studio 6530c (manufactured by Toshiba Tec Corporation), an original with a printing ratio of 8.0% was continuously copied on 300,000 sheets of A4. At that time, the case where an image fault such as white streaks to be caused due to toner adhesion onto the photoconductor was not confirmed was defined as “Good”, and the case where an image fault was confirmed was defined as “Bad”.

### Example 1

Polyester resin (binder): 80 parts by weight

Crystalline polyester resin: 10 parts by weight

Ester Wax (A): 3 parts by weight

Coloring agent (MA-100): 6 parts by weight

Charge control agent (polysaccharide compound containing Al and Mg): 1 part by weight

The foregoing materials were mixed in a Henschel mixer, and the mixture was melt kneaded by a twin-screw extruder. The obtained melt kneaded material was cooled and then coarsely pulverized by a hammer mill. Subsequently, the coarsely pulverized material was finely pulverized by a jet pulverizer and classified, thereby obtaining a powder having a volume average particle size of 7 μm, a toner Tg of 38.9° C. and a difference between a melting point of the crystalline polyester and a melting point of the ester wax of 24° C. To 100 parts by weight of this powder, the following additives were added and mixed in a Henschel mixer, thereby manufacturing a toner.

Monodispersed inorganic fine particle compound, hydrophobic silica having an average primary particle size of 82 nm: 0.8 parts by weight

Hydrophobic silica having an average primary particle size of 30 nm: 1 part by weight

Hydrophobic titanium oxide having an average primary particle size of 20 nm: 0.5 parts by weight

The obtained toner was stirred in a proportion of 6 parts by weight based on 100 parts by weight of a silicone resin-surface coated ferrite carrier having an average particle size of 40 μm in a tabular mixer, thereby obtaining a developing agent. The obtained developing agent was set in a modified machine of a full color copier, the fixing temperature was set to 130° C., and 10 sheets of a solid image with a toner deposition amount of 1.6 mg/cm² were allowed to pass therethrough, and it was confirmed whether or not offset occurred. As a result, it could be confirmed that the offset did not occur. Furthermore, the above-described quality characteristics of life extension and storage characteristic were confirmed. The evaluation results are summarized in Table 4. Incidentally, the toner Tg was determined by using the following apparatus and measurement condition.

0.5 g of the obtained toner was weighed and charged in an Erlenmeyer flask. In the Erlenmeyer flask, 2 mL of methylene chloride was added, thereby dissolving the toner therein. Furthermore, 4 mL of hexane was added, an insoluble matter was filtered off, and the solvent was distilled off in a nitrogen gas stream. A deposit was subjected to FD/MS measurement similar to the case of a simple material of the wax. The measurement results are also summarized in Table 4.

### Toner Tg

The toner Tg is measured by using DSC (DSC Q2000, manufactured by TA Instruments). The measurement is carried out under the following condition.

Sample: 5 mg

Lid and pan: Made of alumina

Temperature elevation rate: 10° C./min

Measurement temperature: 20 to 200° C.

A data obtained by the measurement when the sample heated to 200° C. is cooled to not higher than 20° C. and again heated is employed. Tangents on the low temperature side and the high temperature side of a curve generated at from around 30° C. to around 60° C. are drawn, and a point of intersection of extension lines thereof is defined as Tg.

### Example 2

Polyester resin (binder): 84.5 parts by weight

Crystalline polyester resin: 3 parts by weight

Ester Wax (A): 6 parts by weight

Coloring agent (MA-100): 6 parts by weight

Charge control agent (polysaccharide compound containing Al and Mg): 0.5 parts by weight

The foregoing materials were treated in the same manner as in Example 1, thereby obtaining a powder having a volume average particle size of 7 μm, a toner Tg of 43.4° C. and a difference between a melting point of the crystalline polyester and a melting point of the ester wax of 32° C. To 100 parts by weight of this powder, the following additives were added and mixed in a Henschel mixer, thereby manufacturing a toner.

Monodispersed inorganic fine particle compound, hydrophobic silica having an average primary particle size of 82 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 3

Polyester resin (binder): 62 parts by weight

Crystalline polyester resin: 20 parts by weight

Ester Wax (A): 10 parts by weight

Coloring agent (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm, a toner Tg of 34.1° C. and a difference between a melting point of the crystalline polyester and a melting point of the ester wax of 42° C. To 100 parts by weight of this powder, the following additives were added and mixed in a Henschel mixer, thereby manufacturing a toner.

Monodispersed inorganic fine particle compound, hydrophobic silica having an average primary particle size of 82 nm: 3 parts by weight

Hydrophobic silica having an average primary particle size of 30 nm: 1 part by weight

Hydrophobic titanium oxide having an average primary particle size of 20 nm: 0.5 parts by weight Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 4

Polyester resin (binder): 73 parts by weight

Crystalline polyester resin: 10 parts by weight

Ester Wax (A): 10 parts by weight

Coloring agent (MA-100): 6 parts by weight

Charge control agent (polysaccharide compound containing Al and Mg): 1 part by weight

The foregoing materials were treated in the same manner as in Example 1, thereby obtaining a powder having a volume average particle size of 7 μm, a toner Tg of 35.6° C. and a difference between a melting point of the crystalline polyester and a melting point of the ester wax of 24° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 0.8 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 5

Polyester resin (binder): 84.5 parts by weight

Crystalline polyester resin: 3 parts by weight

Ester Wax (B): 6 parts by weight

Coloring agent (MA-100): 6 parts by weight

Charge control agent (polysaccharide compound containing Al and Mg): 0.5 parts by weight

The foregoing materials were treated in the same manner as in Example 1, thereby obtaining a powder having a volume average particle size of 7 μm, a toner Tg of 43.1° C. and a difference between a melting point of the crystalline polyester and a melting point of the ester wax of 18° C. To 100 parts by weight of this powder, the following additives were added and mixed in a Henschel mixer, thereby manufacturing a toner.

Monodispersed inorganic fine particle compound, hydrophobic silica having an average primary particle size of 198 nm: 0.8 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 6

Polyester resin (binder): 76 parts by weight

Crystalline polyester resin: 6 parts by weight

Ester Wax (B): 10 parts by weight

Coloring agent (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm, a toner Tg of 40.2° C. and a difference between a melting point of the crystalline polyester and a melting point of the ester wax of 26° C. To 100 parts by weight of this powder, the following additives were added and mixed in a Henschel mixer, thereby manufacturing a toner.

Monodispersed inorganic fine particle compound, hydrophobic silica having an average primary particle size of 198 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 7

Polyester resin (binder): 87 parts by weight

Crystalline polyester resin: 3 parts by weight

Ester Wax (B): 3 parts by weight

Coloring agent (MA-100): 6 parts by weight

Charge control agent (polysaccharide compound containing Al and Mg): 1 part by weight

The foregoing materials were treated in the same manner as in Example 1, thereby obtaining a powder having a volume average particle size of 7 μm, a toner Tg of 45.6° C. and a difference between a melting point of the crystalline polyester and a melting point of the ester wax of 36° C. To 100 parts by weight of this powder, the following additives were added and mixed in a Henschel mixer, thereby manufacturing a toner.

Monodispersed inorganic fine particle compound, hydrophobic silica having an average primary particle size of 198 nm: 3 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 8

Polyester resin (binder): 81.5 parts by weight

Crystalline polyester resin: 6 parts by weight

Ester Wax (C): 6 parts by weight

Coloring agent (MA-100): 6 parts by weight

Charge control agent (polysaccharide compound containing Al and Mg): 0.5 parts by weight

The foregoing materials were treated in the same manner as in Example 1, thereby obtaining a powder having a volume average particle size of 7 μm, a toner Tg of 41.6° C. and a difference between a melting point of the crystalline polyester and a melting point of the ester wax of 31° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 9

Polyester resin (binder): 72 parts by weight

Crystalline polyester resin: 10 parts by weight

Ester Wax (C): 10 parts by weight

Coloring agent (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm, a toner

Tg of 35.4° C. and a difference between a melting point of the crystalline polyester and a melting point of the ester wax of 39° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 3.0 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 10

Polyester resin (binder): 75 parts by weight

Crystalline polyester resin: 15 parts by weight

Ester Wax (C): 3 parts by weight

Coloring agent (MA-100): 6 parts by weight

Charge control agent (polysaccharide compound containing Al and Mg): 1 part by weight

The foregoing materials were treated in the same manner as in Example 1, thereby obtaining a powder having a volume average particle size of 7 μm, a toner Tg of 35.9° C. and a difference between a melting point of the crystalline polyester and a melting point of the ester wax of 49° C. To 100 parts by weight of this powder, the following additives were added and mixed in a Henschel mixer, thereby manufacturing a toner.

Monodispersed inorganic fine particle compound, hydrophobic silica having an average primary particle size of 82 nm: 0.8 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Example 11

Polyester resin (binder): 63 parts by weight

Crystalline polyester resin: 20 parts by weight

Ester Wax (C): 10 parts by weight

Coloring agent (MA-100): 6 parts by weight

Charge control agent (polysaccharide compound containing Al and Mg): 1 part by weight

The foregoing materials were mixed in a Henschel mixer, and the mixture was melt kneaded by a twin-screw extruder. The obtained melt kneaded material was cooled and coarsely pulverized by a hammer mill. Subsequently, the coarsely pulverized material was further pulverized using a pulverizer, manufactured by Hosokawa Micron Corporation, thereby obtaining an interim pulverized particle having a volume average particle size of 58 μm. 30 parts by weight of the obtained interim pulverized particle, 1 part by weight of sodium dodecylbenzenesulfonate (NEOPELEX G-15) as an anionic surfactant, 1 part by weight of triethylamine as an amine compound and 68 parts by weight of ion-exchanged water were mixed by a homogenizer, manufactured by IKA, thereby obtaining Mixed Solution 1.

Subsequently, the obtained Mixed Solution 1 was charged in NANO-MIZER (YSNM-2000AR, manufactured by Yoshida Kikai Co., Ltd., to which a heating system was added) in which the heating system temperature was set to 120° C., and treated repeatedly three times under a treatment pressure of 150 MPa. After cooling, a volume average particle size of the obtained colored fine particle was measured by SALD-7000 (manufactured by Shimadzu Corporation), and as a result, it was found to be 0.7 μm. A pH of the fine particle liquid dispersion was 8.2.

Subsequently, the liquid dispersion was diluted such that a solids content of the colored fine particle was 18%, to which was then added dropwise 0.1 M hydrochloric acid, thereby adjusting the pH. The liquid dispersion was controlled to a temperature of 30° C. At a point of time when the pH reached 7.0, the particle size was measured, and as a result, it was found to be 0.85 μm. Furthermore, 0.1 M hydrochloric acid was added dropwise, and at a point of time when a ξ potential of the fine particle reached −30 mV, the dropwise addition was finished. At that time, the pH was 3.9.

Subsequently, the above-described liquid dispersion was subjected to temperature elevation to 80° C. at a rate of 10° C./min while stirring with a paddle blade (at 500 rpm) and then kept at 80° C. for one hour. After cooling, the liquid dispersion was allowed to stand overnight, and the state of a supernatant was observed. As a result, the supernatant was transparent, and any unaggregated particle was not observed. Also, the volume average particle size was measured, and as a result, it was found to be 6 μm, and any coarse particle of 20 μm or more was not observed. Thereafter, the resultant was dried by a vacuum dryer until the water content reached not more than 0.8% by weight, thereby obtaining a powder having a volume average particle size of 6 μm, a toner Tg of 33.4° C. and a difference between a melting point of the crystalline polyester and a melting point of the ester wax of 31° C. To 100 parts by weight of this powder, the following additives were added and mixed in a Henschel mixer, thereby manufacturing a toner.

Monodispersed inorganic fine particle compound, hydrophobic silica having an average primary particle size of 198 nm: 0.3 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 1

Polyester resin (binder): 76 parts by weight

Crystalline polyester resin: 10 parts by weight

Ester Wax (D): 6 parts by weight

Coloring agent (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm, a toner Tg of 40.1° C. and a difference between a melting point of the crystalline polyester and a melting point of the ester wax of 11° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 2

Polyester resin (binder): 80 parts by weight

Crystalline polyester resin: 2 parts by weight

Ester Wax (D): 10 parts by weight

Coloring agent (MA-100): 6 parts by weight

Charge control agent (metal-containing salicylic acid derivative): 2 parts by weight

The foregoing materials were treated in the same manner as in Example 1, thereby obtaining a powder having a volume average particle size of 7 μm, a toner Tg of 50.5° C. and a difference between a melting point of the crystalline polyester and a melting point of the ester wax of 24° C. To 100 parts by weight of this powder, the following additives were added and mixed in a Henschel mixer, thereby manufacturing a toner.

Monodispersed inorganic fine particle compound, hydrophobic silica having an average primary particle size of 75 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 3

Polyester resin (binder): 60 parts by weight

Crystalline polyester resin: 25 parts by weight

Ester Wax (E): 6 parts by weight

Coloring agent (MA-100): 6 parts by weight

Charge control agent (polysaccharide compound containing Al and Mg): 3 parts by weight

The foregoing materials were treated in the same manner as in Example 1, thereby obtaining a powder having a volume average particle size of 7 μm, a toner Tg of 30.4° C. and a difference between a melting point of the crystalline polyester and a melting point of the ester wax of 50° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 4

Polyester resin (binder): 90.5 parts by weight

Crystalline polyester resin: 0 part by weight

Ester Wax (E): 2 parts by weight

Coloring agent (MA-100): 6 parts by weight

Charge control agent (metal-containing salicylic acid derivative): 1.5 parts by weight

The foregoing materials were treated in the same manner as in Example 1, except that the crystalline polyester resin was not added, thereby obtaining a powder having a volume average particle size of 7 μm and a toner Tg of 57.4° C. To 100 parts by weight of this powder, the following additives were added and mixed in a Henschel mixer, thereby manufacturing a toner.

Monodispersed inorganic fine particle compound, hydrophobic silica having an average primary particle size of 82 nm: 0.7 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 5

Polyester resin (binder): 66.5 parts by weight

Crystalline polyester resin: 20 parts by weight

Ester Wax (F): 6 parts by weight

Coloring agent (MA-100): 6 parts by weight

Charge control agent (polysaccharide compound containing Al and Mg): 1.5 parts by weight

The foregoing materials were treated in the same manner as in Example 1, thereby obtaining a powder having a volume average particle size of 7 μm, a toner Tg of 31.1° C. and a difference between a melting point of the crystalline polyester and a melting point of the ester wax of 29° C. To 100 parts by weight of this powder, the following additives were added and mixed in a Henschel mixer, thereby manufacturing a toner.

Monodispersed inorganic fine particle compound, hydrophobic silica having an average primary particle size of 210 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 6

Polyester resin (binder): 57 parts by weight

Crystalline polyester resin: 20 parts by weight

Ester Wax (G): 15 parts by weight

Coloring agent (MA-100): 6 parts by weight

Charge control agent (metal-containing azo compound): 2 parts by weight

The foregoing materials were treated in the same manner as in Example 1, thereby obtaining a powder having a volume average particle size of 7 μm, a toner Tg of 30.1° C. and a difference between a melting point of the crystalline polyester and a melting point of the ester wax of 57° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 7

Polyester resin (binder): 76 parts by weight

Crystalline polyester resin: 10 parts by weight

Ester Wax (H): 6 parts by weight

Coloring agent (MA-100): 6 parts by weight

Charge control agent (metal-containing azo compound and polysaccharide compound containing Al and Mg): 2 parts by weight

The foregoing materials were treated in the same manner as in Example 1, thereby obtaining a powder having a volume average particle size of 7 pin, a toner Tg of 40.6° C. and a difference between a melting point of the crystalline polyester and a melting point of the ester wax of 13° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 8

Polyester resin (binder): 82 parts by weight

Crystalline polyester resin: 0 part by weight

Ester Wax (H): 10 parts by weight

Coloring agent (MA-100): 6 parts by weight

Charge control agent (metal-containing salicylic acid derivative and polysaccharide compound containing Al and Mg): 2 parts by weight

The foregoing materials were treated in the same manner as in Example 1, except that the crystalline polyester resin was not added, thereby obtaining a powder having a volume average particle size of 7 μm and a toner Tg of 54.1° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 9

Polyester resin (binder): 82 parts by weight

Crystalline polyester resin: 0 part by weight

Ester Wax (A): 10 parts by weight

Coloring agent (MA-100): 6 parts by weight

Charge control agent (polysaccharide compound containing Al and Mg): 2 parts by weight

The foregoing materials were treated in the same manner as in Example 1, except that the crystalline polyester resin was not added, thereby obtaining a powder having a volume average particle size of 7 and a toner Tg of 38.5° C. To 100 parts by weight of this powder, the following additives were added and mixed in a Henschel mixer, thereby manufacturing a toner.

Monodispersed inorganic fine particle compound, hydrophobic silica having an average primary particle size of 155 nm: 1.5 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### Comparative Example 10

Polyester resin (binder): 69 parts by weight

Crystalline polyester resin: 20 parts by weight

Ester Wax (B): 3 parts by weight

Coloring agent (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm, a toner Tg of 32.4° C. and a difference between a melting point of the crystalline polyester and a melting point of the ester wax of 13° C. To 100 parts by weight of this powder, the following additives were added and mixed in a Henschel mixer, thereby manufacturing a toner.

Monodispersed inorganic fine particle compound, hydrophobic silica having an average primary particle size of 198 nm: 3.2 parts by weight

Hydrophobic silica having an average primary particle size of 30 nm: 1 part by weight

Hydrophobic titanium oxide having an average primary particle size of 20 nm: 0.5 parts by weight

Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

TABLE 4

| | | Ester wax extracted from toner | | | | | | | | | | |
|---|---|---|---|---|---|---|---|---|---|---|---|---|
| | | Carbon number | | Proportion | | Melting | Difference in | Primary | | Low- | | |
| | | and proportion | | [%] of not | Melting | point | melting point | particle | Addition | temperature | | |
| | | [%] showing | | more than | point | [° C.] of | between wax and | size of | amount of | fixation | Life | |
| | | maximum intensity | | carbon | [° C.] | crystalline | crystalline | external | external | (low- | extension | |
| | Used | Carbon | Proportion | number | of wax | polyester | polyester | additive | additive | temperature | (toner | Film- |
| | wax | number | [%] | C38 | T1 ° C. | T2 ° C. | T ° C. = T2 − T1 | (nm) | (%) | offset) | scattering) | ing |
| Example 1 | A | C44 | 44.9 | 5.4 | 68 | 92 | 24 | 82 | 0.8 | Good | Good | Good |
| Example 2 | A | C44 | 44.3 | 5.6 | 68 | 100 | 32 | 82 | 1.5 | Good | Good | Good |
| Example 3 | A | C44 | 44.5 | 5.7 | 68 | 110 | 42 | 82 | 3.0 | Good | Good | Good |
| Example 4 | A | C44 | 44.8 | 5.4 | 68 | 92 | 24 | 155 | 0.8 | Good | Good | Good |
| Example 5 | B | C44 | 54.6 | 2.6 | 74 | 92 | 18 | 198 | 0.8 | Good | Good | Good |
| Example 6 | B | C44 | 54.8 | 2.8 | 74 | 100 | 26 | 198 | 1.5 | Good | Good | Good |
| Example 7 | B | C44 | 54.5 | 2.5 | 74 | 110 | 36 | 198 | 3.0 | Good | Good | Good |
| Example 8 | C | C40 | 22 | 9.6 | 61 | 92 | 31 | 155 | 1.5 | Good | Good | Good |
| Example 9 | C | C40 | 22.6 | 9.8 | 61 | 100 | 39 | 155 | 3.0 | Good | Good | Good |
| Example 10 | C | C40 | 22.3 | 8.9 | 61 | 110 | 49 | 82 | 0.8 | Good | Good | Good |
| Example 11 | C | C40 | 22.8 | 8.6 | 61 | 92 | 31 | 198 | 3.0 | Good | Good | Good |
| Comparative | D | C44 | 72.6 | 1 | 76 | 87 | 11 | 155 | 1.5 | Good | Bad | Good |
| Example 1 | | | | | | | | | | | | |
| Comparative | D | C44 | 73.4 | 1.6 | 76 | 100 | 24 | 75 | 1.5 | Bad | Bad | Good |
| Example 2 | | | | | | | | | | | | |
| Comparative | E | C44 | 39.4 | 12.6 | 65 | 115 | 50 | 155 | 1.5 | Good | Bad | Good |
| Example 3 | | | | | | | | | | | | |
| Comparative | E | C44 | 40.6 | 12.4 | 65 | Not added | — | 82 | 0.7 | Bad | Bad | Good |
| Example 4 | | | | | | | | | | | | |
| Comparative | F | C40 | 19.1 | 21.6 | 63 | 92 | 29 | 210 | 1.5 | Good | Bad | Bad |
| Example 5 | | | | | | | | | | | | |
| Comparative | G | C32 | 99.7 | 99.4 | 58 | 115 | 57 | 155 | 1.5 | Good | Bad | Good |
| Example 6 | | | | | | | | | | | | |
| Comparative | H | C54 | 18.6 | 0 | 79 | 92 | 13 | 155 | 1.5 | Good | Bad | Good |
| Example 7 | | | | | | | | | | | | |
| Comparative | H | C54 | 19.4 | 0 | 79 | Not added | — | 155 | 1.5 | Bad | Good | Good |
| Example 8 | | | | | | | | | | | | |
| Comparative | A | C44 | 44.3 | 5.7 | 68 | Not added | — | 210 | 3.0 | Good | Good | Bad |
| Example 9 | | | | | | | | | | | | |
| Comparative | B | C44 | 54.1 | 2.5 | 74 | 87 | 13 | 198 | 3.2 | Good | Bad | Bad |
| Example 10 | | | | | | | | | | | | |

According to the foregoing exemplary embodiment or working examples, it is noted that when a toner particle obtained by combining an ester wax which when allowed to stand at a high temperature, is hardly deposited and has favorable high-temperature offset and a crystalline polyester resin having favorable low-temperature offset is combined with an additive with a specified size, a toner which is able to realize low-temperature fixation and also to make it compatible with life extension can be obtained as compared with the related-art toners. The developing agent according to the exemplary embodiment has two melting point temperatures of a melting point temperature derived from the crystalline polyester and a melting point temperature derived from the ester wax. Also, it is effective for the low-temperature fixation that a difference in this melting point temperature is large as from 15° C. to 50° C. Also, as to the ester wax to be used, when an ester wax having a short straight-chain alkyl group is used, the wax dispersibility in the toner becomes favorable, and it is possible to decrease the toner Tg as compared with usual ester waxes. According to this, the fixability becomes favorable even at a low temperature.

As to an evil to be brought due to the simultaneous use of a crystalline polyester resin and an ester wax, there is exemplified the fact that the toner contaminates the carrier surface, so that a charge characteristic during the life tends to be deteriorated. On the other hand, in the developing agent according to the exemplary embodiment, since an additive having a relatively large particle size is added onto the toner particle surface, there was obtained knowledge that it is possible to decrease a contact probability between the toner surface and the carrier surface, whereby low-temperature fixation and life extension can be made compatible with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent comprising a toner containing a toner particle containing a coloring agent, an amorphous polyester, a crystalline polyester having an endothermic peak temperature T1 measured by a differential scanning calorimeter, and an ester wax having an endothermic peak temperature T2 measured by a differential scanning calorimeter; and an additive composed of an inorganic oxide particle added onto the surface of the toner particle and having a volume average particle size of from 80 to 200 nm, the developing agent being satisfied with the following expression (1):
15(° C.)≦|T2−T1|≦50(° C.) (1).

2. The developing agent according to claim 1, wherein the additive is contained in an amount of from 0.1 to 3.0% by weight in the toner.

3. The developing agent according to claim 1, wherein the additive is at least one member selected from the group consisting of silica, titania, alumina, strontium titanate and tin oxide.

4. The developing agent according to claim 1, wherein the ester wax is contained in an amount of from 3 to 17% by weight in the toner particle.

5. The developing agent according to claim 1, wherein the crystalline polyester is contained in an amount of from 3 to 35% by weight in the toner particle.

6. The developing agent according to claim 1, wherein the endothermic peak temperature T1 measured by a differential scanning calorimeter is from 90 to 110° C., and the endothermic peak temperature T2 measured by a differential scanning calorimeter is from 60 to 75° C.

7. The developing agent according to claim 1, wherein the ester wax is an ester wax having an alkyl group with a carbon number of from 32 to 46, in which when an ion intensity ratio at each carbon number of this ester wax is expressed in terms of percentage, a content of the ester compound having a carbon number showing its maximum intensity ratio is from 20 to 55% by weight of the whole of the wax, and a content of the ester compounds with a carbon number of not more than 38 is not more than 10% by weight of the whole of the wax.
